(19) United States
(12) Patent Application Publication
(10) Pub. No.: US 2019/0164205 A1
(43) Pub. Date: May 30, 2019

(54) GENERATING AN ELECTRONIC WARDROBE PROFILE FOR AN INDIVIDUAL USER IN A CUSTOMER ACCOUNT ID

(71) Applicant: INTERNATIONAL BUSINESS MACHINES CORPORATION, Armonk, NY (US)

(72) Inventors: Priyanka Agrawal, Bangalore (IN); Pankaj S. Dayama, Bangalore (IN); Amrita Saha, Nagawara (IN); SRIKANTH Govindaraj TAMILSELVAM, Chennai (IN)

(21) Appl. No.: 15/824,225

(22) Filed: Nov. 28, 2017

(51) Int. Cl. G06Q 30/06; H04L 29/08; G06F 17/30

(52) U.S. Cl. CPC G06Q 30/0613; H04L 67/22; G06Q 50/01; G06Q 30/0631; G06F 17/30867; H04L 67/306

(57) ABSTRACT

A method for building a user wardrobe profile of an individual user within a group having a group account ID. The method receives purchase transaction data associated with the group account ID data, wherein the purchase transaction data comprises data for one or more wardrobe items. The method further detects, in one or more social media posts of the individual user, an electronic representation of the one or more wardrobe items in the purchase transaction data, and builds the user wardrobe profile of the individual user, based on an association between the purchase transaction data and the electronic representation of the one or more wardrobe items detected in the one or more social media posts of the individual user.

### BACKGROUND

Embodiments of the present invention relate generally to the field of computing and more particularly to data processing and generating an individual electronic wardrobe profile for one or more users of a common group of users.

An electronic wardrobe may be a list of wearable items, stored on a user's electronic device such as a mobile device. An individual's electronic wardrobe may be communicated by a user's mobile device, and/or social media platforms, to selected recipients. Recipients of an individual's electronic wardrobe may be friends, family, or even people that a user does not know. Users may have various reasons for communicating an electronic wardrobe list, or collection, to others. Receivers of the electronic wardrobe collection, too, may have various reasons for wanting to receive the electronic wardrobe from an individual user. Some of those reasons may include: (1) assigning a rating to the wardrobe collection; (2) finding details (e.g. manufacturer, price, materials) of an item in the wardrobe collection; (3) recommending a next possible purchase to a user based on the wardrobe collection; and (4) recommending items for vacation, or specific events, from the wardrobe collection.

Currently, one of the known methods for generating an electronic wardrobe of a user includes detecting a user's purchase of a wearable item via an e-commerce account. Another known method includes detecting, via a cognitive device, wearable items in a user's closet. These two methods have shortcomings. They require additional hardware devices and also do not cover all possible information sources for generating an electronic wardrobe of an individual user within a common user account, or group. For example, one e-commerce account may be used by multiple users, thereby making it more difficult to identify various user profiles and their associated electronic wardrobe. Furthermore, the user may need an additional dedicated device to detect items inside their closet, and the user may encounter an overload of needed devices in the event there are multiple closets.

Oftentimes, an online e-commerce account for a family, or any other group account, may include transaction data for all members of the group without making a distinction between the items purchased by certain individuals of the group, thereby making it more difficult to identify various user profiles and their associated electronic wardrobe.

### SUMMARY

Embodiments of the invention include a method, computer program product, and system, for building a user wardrobe profile of an individual user within a group having a customer account identification (ID), such as an e-commerce account.

A method, according to an embodiment of the invention, receives purchase transaction data associated with the customer account ID data, wherein the purchase transaction data comprises data for one or more wardrobe items. The method further detects, in one or more social media posts of the individual user, an electronic representation of the one or more wardrobe items in the purchase transaction, and builds the user wardrobe profile of the individual user, based on an association between the purchase transaction data and the electronic representation of the one or more wardrobe items detected in the one or more social media posts of the individual user.

A computer program product, according to an embodiment of the invention, includes a non-transitory tangible storage device having program code embodied therewith. The program code is executable by a processor of a computer to perform a method. The method receives purchase transaction data associated with the customer account ID data, wherein the purchase transaction data comprises data for one or more wardrobe items. The method further detects, in one or more social media posts of the individual user, an electronic representation of the one or more wardrobe items in the purchase transaction, and builds the user wardrobe profile of the individual user, based on an association between the purchase transaction data and the electronic representation of the one or more wardrobe items detected in the one or more social media posts of the individual user.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method receives purchase transaction data associated with the customer account ID data, wherein the purchase transaction data comprises data for one or more wardrobe items. The method further detects, in one or more social media posts of the individual user, an electronic representation of the one or more wardrobe items in the purchase transaction, and builds the user wardrobe profile of the individual user, based on an association between the purchase transaction data and the electronic representation of the one or more wardrobe items detected in the one or more social media posts of the individual user.

### BRIEF DESCRIPTION OF THE SEVERAL VIEWS OF THE DRAWINGS

FIG. 1 illustrates electronic wardrobe computing environment 100, in accordance with an embodiment of the present invention.

FIG. 2 is a flowchart illustrating the operation of electronic wardrobe assistant 120 of FIG. 1, in accordance with an embodiment of the present invention.

FIG. 3 is a diagram graphically illustrating the hardware components of electronic wardrobe computing environment 100 of FIG. 1, in accordance with an embodiment of the present invention.

FIG. 4 depicts a cloud computing environment, in accordance with an embodiment of the present invention.

FIG. 5 depicts abstraction model layers of the illustrative cloud computing environment of FIG. 4, in accordance with an embodiment of the present invention.

### DETAILED DESCRIPTION

E-commerce often relies on electronic user profiles. These profiles are used to examine user purchase habits and needs, and to make recommendations to users about what they should buy. Users often make these decisions themselves or rely on human experts to guide them in their purchases. In the prior art, computer systems merely automate the recommendation process based on mimicking factors that a human actor may consider (e.g., a user belonging to a young demographic may prefer some wardrobe items over others, so the computer checks to see if a given user falls into the young demographic and automatically makes the recommendation).

However, in the prior art, a computer cannot make a recommendation where there is no individual profile data associated for the user. For example, if it is unknown whether a user belongs to a particular demographic, the computer cannot use that as a feature based on which the user receives a recommendation. Some attempts have been made to ascertain profile data for a user based on the user's purchase history. For example, if a user consistently purchases an item of clothing suitable for a young demographic group, current solutions may infer that the user belongs to a young demographic group and should receive corresponding recommendations.

A challenge that current computer systems cannot handle, however, is that purchase transaction data for a user (e.g. a customer account in an e-commerce website) is used for multiple individuals who may or may not be “the user”. For example, an adult member of a family may create a customer account on an e-commerce website. The adult member, or any member of the family, may make wardrobe purchases for themselves and/or for others in the family, all using the same customer account. From a technological perspective, however, the computer is blind as to which family member a particular wardrobe item is intended for, if any.

This is an entirely technological problem. Embodiments of the invention solve the technical problem of making individual-level data inferences from a group-level collection of data by examining both electronic records of purchase transaction data and social media data of latent user profiles (e.g. status updates, user profile, user connections, etc.) of the customer account ID under consideration. In practice, this means that individuals' social media data can be used to improve their associated latent individual-level profile data, within a customer account ID, without directly collecting this data from each individual user. Embodiments of the invention derive individual-level data without having been provided that data directly from any source. Rather, embodiments of the invention engage in the technologically robust process of social media data mining and analysis, such as image analysis and natural language processing.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

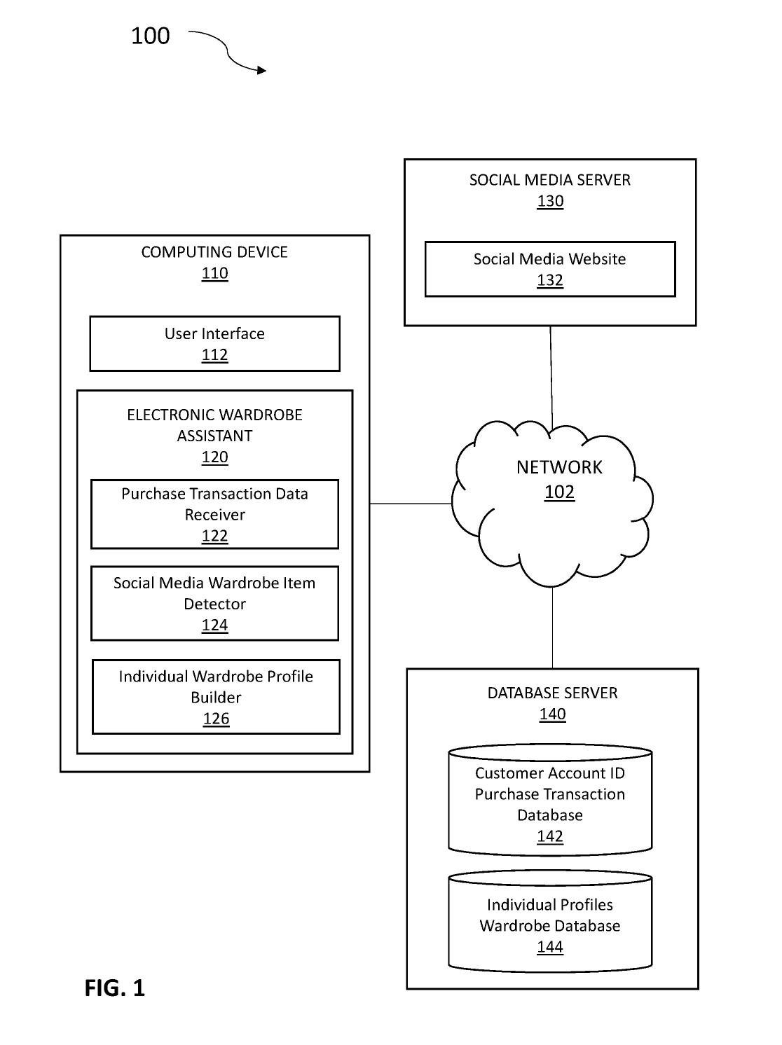

FIG. 1 illustrates electronic wardrobe computing environment 100, in accordance with an embodiment of the present invention. Electronic wardrobe computing environment 100 includes computing device 110, social media server 130, and database server 140 all connected via network 102. The setup in FIG. 1 represents an example embodiment configuration for the present invention, and is not limited to the depicted setup in order to derive benefit from the present invention.

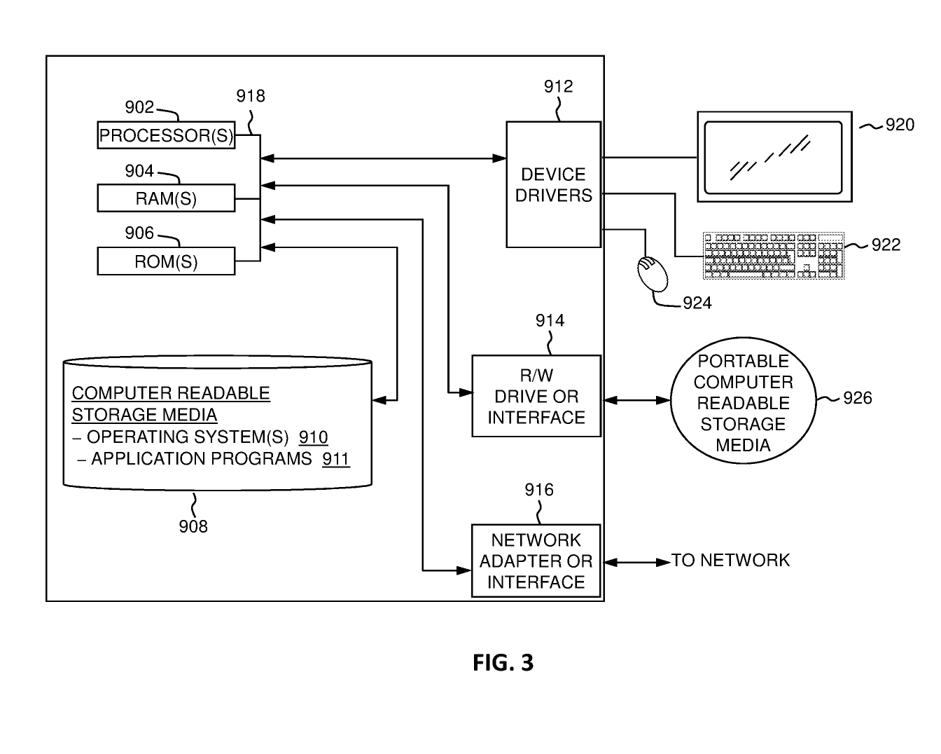

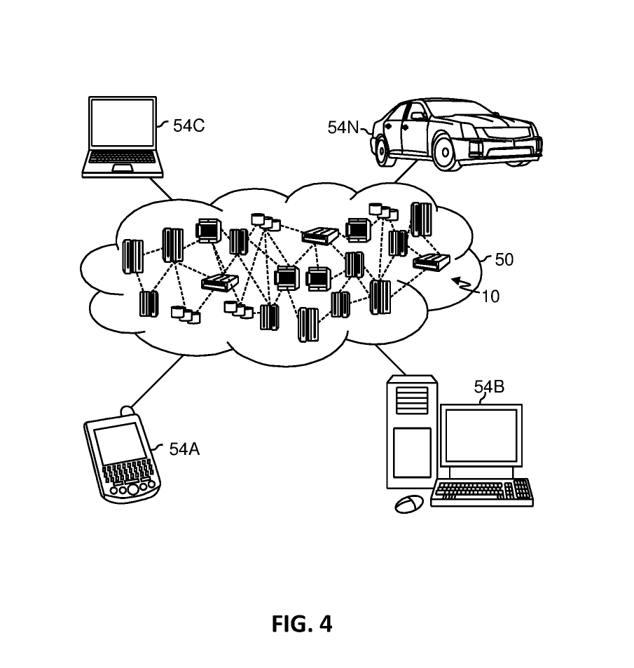

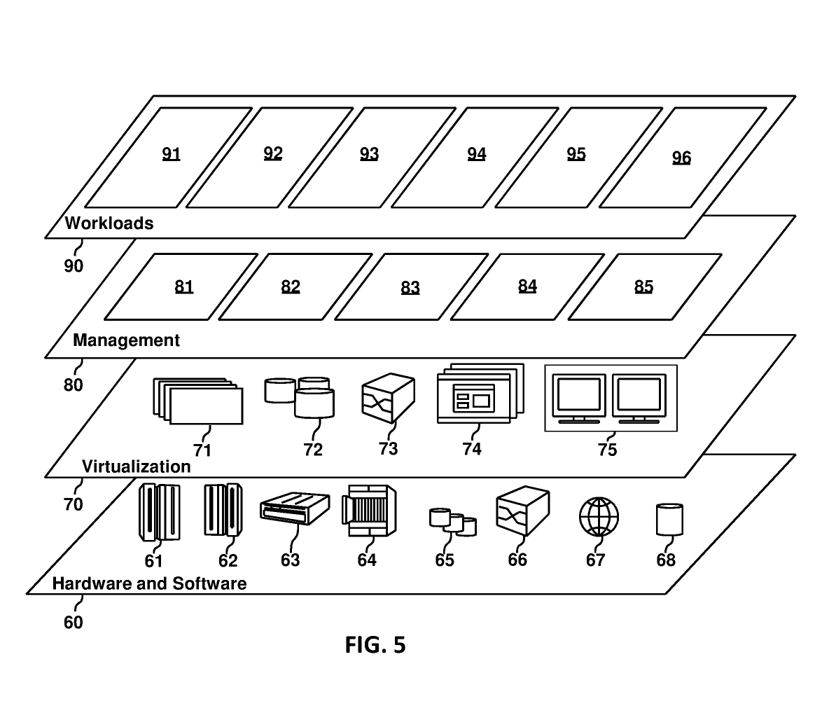

In an example embodiment, computing device 110 contains user interface 112 and electronic wardrobe assistant 120. In various embodiments, computing device 110 may be a laptop computer, tablet computer, netbook computer, personal computer (PC), a desktop computer, a personal digital assistant (PDA), a smart phone, or any programmable electronic device capable of communicating with social media server 130 and database server 140 via network 102. Computing device 110 may include internal and external hardware components, as depicted and described in further detail below with reference to FIG. 3. In other embodiments, computing device 110 may be implemented in a cloud computing environment, as described in relation to FIGS. 4 and 5, herein. Computing device 110 may also have wireless connectivity capabilities allowing it to communicate with social media server 130, database server 140, and other computers or servers over network 102.

In the example embodiment, computing device 110 includes user interface 112, which may be a computer program that allows a user to interact with computing device 110 and other connected devices via network 102. For example, user interface 112 may be a graphical user interface (GUI). In addition to comprising a computer program, user interface 112 may be connectively coupled to hardware components, such as those depicted in FIG. 3, for receiving user input. In the example embodiment, user interface 112 is a web browser, however in other embodiments user interface 112 may be a different program capable of receiving user interaction and communicating with other devices.

In the example embodiment, social media server 130 includes social media website 132, and may be a laptop computer, tablet computer, netbook computer, personal computer (PC), a desktop computer, a personal digital assistant (PDA), a smart phone, a server, or any programmable electronic device capable of communicating with computing device 110 and database server 140 via network 102. While social media server 130 is shown as a single device, in other embodiments, social media server 130 may be comprised of a cluster or plurality of computing devices, working together or working separately.

In an example embodiment, social media website 132 is a website capable of hosting social media content shared between registered users, including user profiles and social media posts. For example, social media website 132 is capable of receiving manually input status updates of a user, location of a user, posted images (i.e. photographs) of a user, natural language comments associated with a posted image, status update, and/or location of a user, streaming/live video, check-ins at restaurant/bar/stadium establishments, and so forth, from a user, which may be consolidated and analyzed and provide a glimpse into personality traits, social activity patterns, and wardrobe preferences of a user. The more frequently, consistently, and accurately a user interacts with a social media application (e.g. social media website 132) the more genuine of a measurement of social patterns, personality traits, and wardrobe preferences of a user may be obtained.

In an example embodiment, social media website 132 is accessed via an internet browser, such as user interface 112 on computing device 110. In other embodiments, however, social media website 132 may be accessed via other means, or may be a standalone program.

In various embodiments, social media website 132 may be a collection of files, including, but not limited to, for example, HTML files, CSS files, XML files, image files and JavaScript files. Social media website 132 can also include other resources such as audio files and video files. In an exemplary embodiment, social media website 132 may be a social media website such as Facebook® (Facebook is a registered trademark of Facebook, Inc.), Twitter® (Twitter is a registered trademark of Twitter, Inc.), LinkedIn® (LinkedIn is a registered trademark of LinkedIn Corporation), or Instagram® (Instagram is a registered trademark of Instagram, LLC).

With continued reference to FIG. 1, database server 140 includes customer account ID purchase transaction database 142 and individual profiles wardrobe database 144 and may be a laptop computer, tablet computer, netbook computer, personal computer (PC), a desktop computer, a personal digital assistant (PDA), a smart phone, a server, or any programmable electronic device capable of communicating with computing device 110 and social media server 130 via network 102. While database server 140 is shown as a single device, in other embodiments, database server 140 may be comprised of a cluster or plurality of computing devices, working together or working separately.

In an exemplary embodiment, customer account ID purchase transaction database 142 stores purchase transaction data received from an e-commerce customer account, or from manually input paper receipts received by a customer from a store, and logs all purchase transaction data, such as wearable items, purchased under a customer account ID, or a common group account, registered to an individual owner. In exemplary embodiments, purchase transaction data may include a short description of a purchased item (i.e. brown long sleeve round-neck sweater, brand name T-shirt, blue golf shirt, black skinny capris, red high-heels, sneakers, tan shorts, diamond necklace, flower-print blouse), a price of the purchased item, a size of the purchased item, and the date of purchase. In alternative embodiments, purchase transaction data may include more descriptive data or less descriptive data based on the pre-configured parameters of the e-commerce website or store.

In exemplary embodiments, customer account ID purchase transaction database 142 may include a customer profile in relation to the customer account ID, whereby electronic wardrobe assistant 120 may automatically infer the composition of the customer account ID based on the purchase transaction history of the account holder by identifying genders, potential age ranges of individual members of the customer account ID, and so forth. In alternative embodiments, a user may manually input a composition of a customer account ID, for example: mom, dad, son, and daughter.

With reference to an illustrative example, Customer Account ID: “Family XYZ” may include the following stored data, in customer account ID purchase transaction database 142, based on Family XYZ purchases: “<Family XYZ-Wardrobe Profile>”: # items: 30; # items in social platform: 12; Periodicity: 3 weeks; Frequent store: Shoppers Shop; Exclusivity: Strong; Repeatability: Weak; Social Network: common social media platforms; Time Spent stats: ˜10 mins/item; Most popular item: brand name T-shirt (120 likes, 50 comments), etc.

In exemplary embodiments, individual profiles wardrobe database 144 receives input from electronic wardrobe assistant 120 and customer account ID purchase transaction database 142, and stores purchase transaction data for wearable items pertaining specifically to an individual within the customer account ID. For example, a family customer account ID comprising mom, dad, and two daughters may have their own individual customer profiles, further including the specific wearable items purchased under the one customer account ID, such as <Family Member Profile 1, Male, 40, sneakers, brand name T-shirt, etc.>; <Family Member Profile 2, Female, 39, flower-print blouse, diamond earrings, etc.>; <Family Member Profile 3, Female, 28, black skinny capris, red high-heels, etc.>; and <Family Member Profile 4, Female, 26, green skirt, black stockings, etc.>.

In various embodiments, customer account ID purchase transaction database 142 and/or individual profiles wardrobe database 144 are capable of being stored on electronic wardrobe assistant 120, or computing device 110, as a separate database.

With continued reference to FIG. 1, electronic wardrobe assistant 120, in the example embodiment, may be a computer application on computing device 110 that contains instruction sets, executable by a processor. The instruction sets may be described using a set of functional modules. Electronic wardrobe assistant 120 receives input from social media server 130 and database server 140. In alternative embodiments, electronic wardrobe assistant 120 may be a standalone program on a separate electronic device or server.

In an exemplary embodiment, the functional modules of electronic wardrobe assistant 114 include purchase transaction data receiver 122, social media wardrobe item detector 124, and individual wardrobe profile builder 126.

With continued reference to FIG. 1, electronic wardrobe assistant 120 is capable of receiving purchase transaction data associated with the customer account ID data, wherein the purchase transaction data comprises data for one or more wardrobe items. The method is further capable of analyzing one or more social media posts of latent individual group members, and detecting, in the social media post of the latent individual group member, a representation of a wardrobe item in the purchase transaction data. The method is further capable of associating the purchase transaction data, for the wardrobe item detected in the social media post, with a profile of the individual group member, and building an individual purchase transaction profile for the individual user based on the associated purchase transaction data.

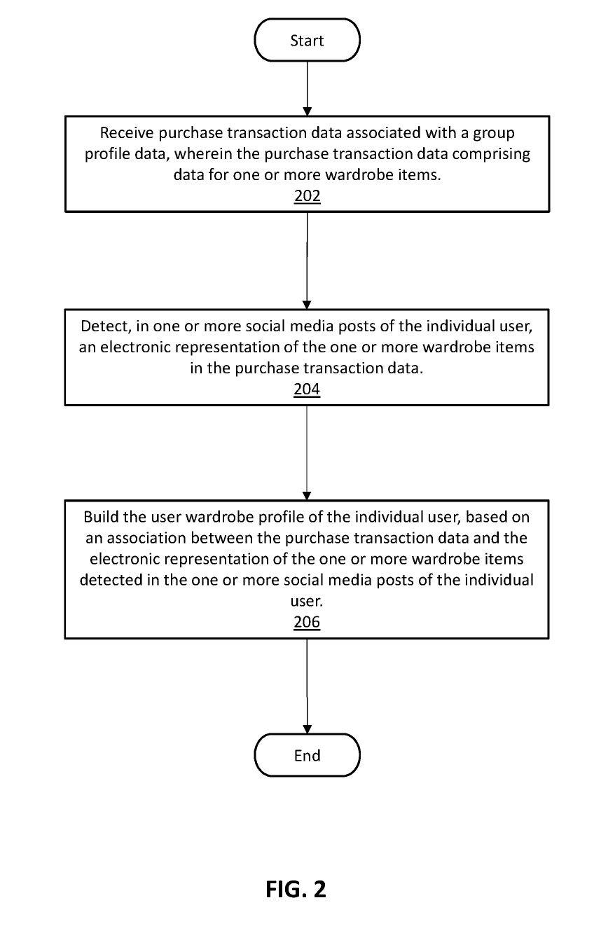

FIG. 2 is a flowchart illustrating the operation of electronic wardrobe assistant 120 of FIG. 1, in accordance with an embodiment of the present invention.

With reference to FIGS. 1 and 2, purchase transaction data receiver 122 includes a set of programming instructions, in electronic wardrobe assistant 120, to receive purchase transaction data associated with the customer account ID data, wherein the purchase transaction data comprises data for one or more wardrobe items (step 202). In exemplary embodiments, customer account ID data may include two or more users with varying characteristics (i.e. age, gender, etc.), wherein the varying characteristics may be inferred from purchase transaction data. For example, if the purchase transaction data consistently includes wearable items for a 26-year-old female, then electronic wardrobe assistant 120 may infer, with a certain degree of confidence level, that a 26-year-old female is a member of the customer account ID. On the other hand, a single item, such as a pair of overalls for a child, may be a gift for a third party and therefore not attributable to any of the individual user profiles of the customer account ID.

In exemplary embodiments, purchase transaction data receiver 122 is capable of obtaining purchase transaction data for a group user account, or customer account ID, wherein the purchase transaction data may include online or in-store purchases of wearable items. A wearable item may include an article of clothing (e.g. a shirt, a dress, pants, shorts, etc.), footwear (e.g. sneakers, shoes, flip-flops, etc.), jewelry (e.g. necklace, earring, ring, etc.), headwear (e.g. hat, hairclip, etc.), and almost anything that may be worn by a person.

In exemplary embodiments, the customer account ID may include latent groups of individuals (e.g. members of the same family) who make wardrobe purchases from a single purchase account. In other words, the purchase transaction data is not specific to a particular individual of the group, but rather to the customer account ID associated with the group user account.

In exemplary embodiments, purchase transaction data receiver 122 may be capable of identifying a member of the customer account ID based on the wardrobe-specific purchase. For example, an earrings and skinny capris purchase may be associated with a female member of the customer account ID, while a baseball hat and football jersey purchase may be associated with a male member of the customer account ID.

In an exemplary embodiment, electronic wardrobe assistant 120 may be capable of preliminarily identifying various users from a customer account ID, based on information received from purchase transaction data receiver 122, and begin generating individual electronic wardrobe profiles for potential members of the customer account ID. For example, generation of an individual user wardrobe, from the customer account ID, may be based on a segment-category model wherein the following information is considered: (1) customer segments, such as gender and potential age range of a user; (2) purchase transaction records; and (3) observed item categories, such as jewelry, female (child or adult) shirts/pants, male (child or adult) shirts/pants.

With continued reference to FIGS. 1 and 2, social media wardrobe item detector 124 includes a set of programming instructions, in electronic wardrobe assistant 120, to detect, in one or more social media posts of the individual user, an electronic representation of the one or more wardrobe items in the purchase transaction data (step 204). In exemplary embodiments, commonly used social analytics tools may be seeded with the owner's profile of the customer account ID. The owner's profile, in an exemplary embodiment, may contain identifying information such as name, age, credit card information, address, etc. The commonly used social analytics tools (e.g. engagement statistics, viewing and posting activity, family tree, syncing and cross-referencing multiple social media platforms, etc.) may then determine a profile of other members of the customer account ID, who most likely use the e-commerce account for purchases, from the owner's profile on social networks such as social media websites 132.

In exemplary embodiments, social media wardrobe item detector 124 is capable of distinguishing between various individual members within a customer account ID based on input from the various individual members' social media websites 132. For example, a social media post on an individual user's, or a connection of the individual user's (e.g. friend, family member, etc.), social media website 132 may include a photograph, a video, a status update, a like, a comment, a reference to the individual user, and/or a reference to another individual user within the group user account (i.e. customer account ID) or outside the group user account. In alternative embodiments, electronic wardrobe assistant 120 may sync, or link, a social media profile image of individual users, of the customer account ID, with an individual user wardrobe profile of the customer account ID based on identified wardrobe items in social media posts associated with the individual user. In further embodiments, an individual user's social media profile image can be used to associate purchased wardrobe items, derived from purchase transaction data, by comparing a description of the purchased wardrobe items with the wardrobe items depicted in social media posts.

In an exemplary embodiment, the assertion and update of individual member profiles, within a customer account ID, from social media websites 132 are performed on a continuous basis. In various embodiments, social media wardrobe item detector 124 crawls various social media websites 132 on the worldwide web to find references (i.e. photos, videos, images, natural language text) to an individual user within the customer account ID and an associated wearable item, or a possible associated wearable item, based on purchase transaction data of the customer account ID stored in customer account ID purchase transaction database 142.

In alternative embodiments, social media wardrobe item detector 124 may receive a list, from the customer account ID owner, of the individual users within the customer account ID, together with a list of social media websites 132 that the individual users are registered with.

In exemplary embodiments, social media wardrobe item detector 124 is further capable of detecting, in the one or more social media posts of the individual user, an electronic representation of the one or more wardrobe items in the purchase transaction data, by performing image analysis on the one or more social media posts of the individual user and identifying one or more images, in the one or more social media posts of the individual user, as being associated with the one or more wardrobe items in the received purchase transaction data.

In an exemplary embodiment, social media wardrobe item detector 124 may associate a latent individual user, within the customer account ID, with the one or more identified images in the one or more social media posts, based on facial recognition analysis.

In other embodiments, various types of image analysis, in addition to facial recognition analysis, may include age detection analysis, object character recognition (OCR) analysis, and any other type of image analysis for identifying features of objects or people within images, known to one of ordinary skill in the art.

In certain scenarios, there may be multiple individual users of similar age and gender associated with the customer account ID, and therefore identifying the individual for whom a purchased wearable item belongs may not be so easy. In exemplary embodiments, electronic wardrobe assistant 120 may overcome this obstacle by performing image analysis on one or more posted images of the one or more users with the one or more wearable items, and associate a purchased wardrobe item with a particular user based on facial recognition analysis. In various exemplary embodiments, natural language text analysis of social media posts may additionally prove beneficial in identifying individual users with one or more purchased wardrobe items.

With continued reference to the illustrative example above, social media wardrobe item detector 124 may detect a woman's flower-print blouse in a social media post of <Family Member 3, Female, 28>. The posted image of a female wearing the identified purchased item (e.g. flower-print blouse), on Family Member 3's social media website, does not necessarily indicate that the blouse belongs in Family Member 3's electronic wardrobe profile, since there is a similar profile for <Family Member 4, Female, 26>. In order to identify the detected wardrobe item in the social media post as belonging to an individual member associated with the customer account ID, electronic wardrobe assistant 120 may perform image analysis of the person and the wearable item in the social media post. In this example, social media wardrobe item detector 124 may identify the correct individual user, within the customer account ID, of the flower-print blouse based on facial recognition analysis.

With reference to another example of performing image analysis on social media posts, social media wardrobe item detector 124 may differentiate identical twins and/or individual users with identical physical characteristics, in the one or more social media posts of the individual user, based on a color of the one or more wardrobe items associated with the individual user in the one or more social media posts. Social media wardrobe item detector 124 may be capable of associating a particular color shirt with a particular individual user, based on analyzing an individual user's electronic wardrobe profile and inferring an individual user's color preference based on the individual user's electronic wardrobe profile.

In alternative embodiments, social media wardrobe item detector 124 may detect at least one personality insight of an individual user, based on the color of the one or more wardrobe items associated with the individual user in the one or more social media posts, and rank the one or more wardrobe items associated with the latent individual user based on the at least one detected personality insight, and a confidence level.

With reference to an illustrative example, a mom may post a photo, on a social media platform, of her 5-year-old twin girls wearing the same dress, but in different colors. The purchase transaction data may only indicate two dresses, and not include the colors. Social media wardrobe item detector 124 may associate the red dress with a particular personality trait of one of the twins, while associating the yellow dress with a particular personality trait of the other twin. For example, the color red is associated with Lisa, who has an outgoing personality, and the color yellow is associated with Mary, who has a reserved personality.

In alternative embodiments, social media wardrobe item detector 124 may associate the red dress with a particular twin based on prior posted images of the same twin wearing red, or a similar color. For example, the twin who typically wears red is Lisa, and the twin who typically wears yellow is Mary.

With continued reference to FIG. 1 and the implementation of electronic wardrobe assistant 120, social media wardrobe item detector 124 may perform natural language text analysis on the one or more social media posts of a latent individual user and identify one or more spans of natural language text, in the one or more social media posts of the latent individual user, as being associated with one or more words describing the one or more wardrobe items in the received purchase transaction data. For example, in a particular embodiment, purchase transaction data may comprise <red dress, size Large, $19.95, 11/17/17>. In the same embodiment, a social media post of an individual user may include a photo with a caption, or comment, that reads “Jennifer, I love your red dress!” Social media wardrobe item detector 124 may associate the span of text “red dress” in the purchase transaction data with the span of text “red dress” in the social media post of the individual user, and draw an association between the two. In this fashion, social media wardrobe item detector 124 may then associate the latent individual user, within the customer account ID, with the one or more wardrobe items in the one or more social media posts, based on the identified one or more spans of natural language text.

In exemplary embodiments, social media wardrobe item detector 124 may monitor, continuously, the one or more social media posts of the individual group member, link a positive social media interaction of the individual user with a third party social media post depicting the one or more wardrobe items identified in the received purchase transaction data, and associate the one or more depicted wardrobe items with the user wardrobe profile of the individual user.

In an exemplary embodiment, comments associated with a social media post (e.g. image, video, etc.) may provide an indication that the social media post depicts the individual user, within a customer account ID, wearing one of the purchased wardrobe items. Social media wardrobe item detector 124 may utilize a natural language text processing tool that is capable of identifying an individual user in a social media post (e.g. natural language text) by identifying the individual's name, identifying a snippet of text describing the purchased wardrobe item, and/or matching a purchase date of the wearable item with the date of the social media post containing the identified wearable item. For example, if a wearable item was purchased on Nov. 17, 2017 and the social media post identifying the wearable item is dated Oct. 31, 2015 then social media wardrobe item detector 124 may determine that the identified item cannot be the purchased wearable item. On the other hand, if social media wardrobe item detector 124 identifies the wearable item in a social media post of the individual user on Nov. 22, 2017, then social media item detector 124 may determine, with a high confidence level, that the identified item is the purchased wearable item, and associate the wearable item with the individual user's electronic wardrobe profile. In exemplary embodiments, social media wardrobe item detector 124 may not assign a particular wearable item to an individual user wardrobe profile, within a customer account ID, unless a confidence level meets a certain threshold value.

In an alternative embodiment, electronic wardrobe assistant 120 may receive optional inputs, such as global positioning system (GPS) data to reflect a location of the user at the time of an in-store purchase. The in-store purchases may either be for the user or for others, and would then require a verification. Therefore, this optional input embodiment may not be so accurate for the present system. However, this optional input may be used to enrich a user-wardrobe profile, for example by utilizing the amount of the purchase, time, chronological order of purchases, etc.

With continued reference to FIGS. 1 and 2, individual wardrobe profile builder 126 includes a set of programming instructions, in electronic wardrobe assistant 120, to build the user wardrobe profile of the individual user, based on an association between the purchase transaction data and the electronic representation of the one or more wardrobe items detected in the one or more social media posts of the individual user (step 206). In exemplary embodiments, individual wardrobe profile builder 126 adds purchased wardrobe items, based on an identified association with an individual user associated with a customer account ID, to an electronic wardrobe profile of the individual user, and stores same in individual profiles wardrobe database 144.

In exemplary embodiments, the individual account holder may manually correct electronic wardrobe assistant 120 when a wardrobe item is incorrectly placed into an individual user's electronic wardrobe profile. Individual wardrobe profile builder 126 may be capable of learning, via machine learning techniques, the reason why the wardrobe item belongs in one individual user's electronic wardrobe profile over another's. The more data presented to electronic wardrobe assistant 120, the stronger the confidence levels will be when assigning a purchased wardrobe item to an individual user's wardrobe profile, within a customer account ID.

In the example embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between computing device 110, social media server 130, and database server 140.

FIG. 3 is a block diagram depicting components of a computing device in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device of FIG. 3 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as electronic wardrobe assistant 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 3 may also include a R/W drive or interface 914 to read from and write to one or more portable computer readable storage media 926. Application programs 911 on computing device 110 may be stored on one or more of the portable computer readable storage media 926, read via the respective R/W drive or interface 914 and loaded into the respective computer readable storage media 908.

Computing device of FIG. 3 may also include a network adapter or interface 916, such as a TCP/IP adapter card or wireless communication adapter (such as a 4G wireless communication adapter using OFDMA technology). Application programs 911 on computing device of FIG. 3 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 3 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; analytics services 96, including those described in connection with FIGS. 1-5.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for building a user wardrobe profile of an individual user within a group having a group profile, comprising:
receiving purchase transaction data associated with the group profile, wherein the purchase transaction data comprises data for one or more wardrobe items;
detecting, in one or more social media posts of the individual user, an electronic representation of the one or more wardrobe items in the purchase transaction data; and
building the user wardrobe profile of the individual user, based on an association between the purchase transaction data and the electronic representation of the one or more wardrobe items detected in the one or more social media posts of the individual user.

2. The computer-implemented method of claim 1, wherein the data for one or more wardrobe items comprises any one or more of a purchase date, one or more words describing the one or more wardrobe items, a size of the item, and a purchase price.

3. The computer-implemented method of claim 1, wherein detecting, in the one or more social media posts of the individual user, an electronic representation of the one or more wardrobe items in the purchase transaction data comprises:
performing image analysis on the one or more social media posts of the individual user; and
identifying one or more images, in the one or more social media posts of the individual user, as being associated with the one or more wardrobe items in the received purchase transaction data.

4. The computer-implemented method of claim 3, further comprising:
associating the individual user within the group with the one or more identified images in the one or more social media posts, based on facial recognition analysis.

5. The computer-implemented method of claim 4, further comprising:
differentiating identical twins, and individual users with identical physical characteristics, in the one or more social media posts of the individual user, based on a color of the one or more wardrobe items associated with the individual user in the one or more social media posts.

6. The computer-implemented method of claim 5, further comprising:
detecting at least one personality insight of the individual user, based on the color of the one or more wardrobe items associated with the individual user in the one or more social media posts; and
ranking, based on a confidence level, the one or more wardrobe items associated with the individual user.

7. The computer-implemented method of claim 1, wherein detecting, in the one or more social media posts of the individual user, an electronic representation of the one or more wardrobe items in the purchase transaction data, comprises:
performing natural language text analysis on the one or more social media posts of the individual user; and
identifying one or more spans of natural language text, in the one or more social media posts of the individual user, as being associated with one or more words describing the one or more wardrobe items in the received purchase transaction data.

8. The computer-implemented method of claim 7, further comprising:
associating the individual user within the group with the one or more wardrobe items in the one or more social media posts, based on the identified one or more spans of natural language text.

9. The computer-implemented method of claim 1, further comprising:
monitoring, continuously, the one or more social media posts of the individual group member;
linking a positive social media interaction of the individual user with a third party social media post depicting the one or more wardrobe items identified in the received purchase transaction data; and
associating the one or more depicted wardrobe items with the user wardrobe profile of the individual user.

10. A computer program product, comprising a non-transitory tangible storage device having program code embodied therewith, the program code executable by a processor of a computer to perform a method, the method comprising:
receiving purchase transaction data associated with the group profile, wherein the purchase transaction data comprises data for one or more wardrobe items;
detecting, in one or more social media posts of the individual user, an electronic representation of the one or more wardrobe items in the purchase transaction data; and
building the user wardrobe profile of the individual user, based on an association between the purchase transaction data and the electronic representation of the one or more wardrobe items detected in the one or more social media posts of the individual user.

11. The computer program product of claim 10, wherein the data for one or more wardrobe items comprises any one or more of a purchase date, one or more words describing the one or more wardrobe items, a size of the item, and a purchase price.

12. The computer program product of claim 10, wherein detecting, in the one or more social media posts of the individual user, an electronic representation of the one or more wardrobe items in the purchase transaction data comprises:
performing image analysis on the one or more social media posts of the individual user; and
identifying one or more images, in the one or more social media posts of the individual user, as being associated with the one or more wardrobe items in the received purchase transaction data.

13. The computer program product of claim 10, wherein detecting, in the one or more social media posts of the individual user, an electronic representation of the one or more wardrobe items in the purchase transaction data, comprises:
performing natural language text analysis on the one or more social media posts of the individual user; and
identifying one or more spans of natural language text, in the one or more social media posts of the individual user, as being associated with one or more words describing the one or more wardrobe items in the received purchase transaction data.

14. The computer program product of claim 13, further comprising:
associating the individual user within the group with the one or more wardrobe items in the one or more social media posts, based on the identified one or more spans of natural language text.

15. The computer program product of claim 10, further comprising:
monitoring, continuously, the one or more social media posts of the individual group member;
linking a positive social media interaction of the individual user with a third party social media post depicting the one or more wardrobe items identified in the received purchase transaction data; and
associating the one or more depicted wardrobe items with the user wardrobe profile of the individual user.

16. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
receiving purchase transaction data associated with the group profile, wherein the purchase transaction data comprises data for one or more wardrobe items;
detecting, in one or more social media posts of the individual user, an electronic representation of the one or more wardrobe items in the purchase transaction data; and
building the user wardrobe profile of the individual user, based on an association between the purchase transaction data and the electronic representation of the one or more wardrobe items detected in the one or more social media posts of the individual user.

17. The computer system of claim 16, wherein the data for one or more wardrobe items comprises any one or more of a purchase date, one or more words describing the one or more wardrobe items, a size of the item, and a purchase price.

18. The computer system of claim 16, wherein detecting, in the one or more social media posts of the individual user, an electronic representation of the one or more wardrobe items in the purchase transaction data comprises:
performing image analysis on the one or more social media posts of the individual user; and
identifying one or more images, in the one or more social media posts of the individual user, as being associated with the one or more wardrobe items in the received purchase transaction data.

19. The computer system of claim 16, wherein detecting, in the one or more social media posts of the individual user, an electronic representation of the one or more wardrobe items in the purchase transaction data, comprises:
performing natural language text analysis on the one or more social media posts of the individual user; and
identifying one or more spans of natural language text, in the one or more social media posts of the individual user, as being associated with one or more words describing the one or more wardrobe items in the received purchase transaction data.

20. The computer system of claim 16, further comprising:
monitoring, continuously, the one or more social media posts of the individual group member;
linking a positive social media interaction of the individual user with a third party social media post depicting the one or more wardrobe items identified in the received purchase transaction data; and
associating the one or more depicted wardrobe items with the user wardrobe profile of the individual user.
